(19) United States
(12) Patent Application Publication
(10) Pub. No.: US 2026/0189139 A1
(43) Pub. Date: Jul. 2, 2026

(54) POWER CONVERSION SYSTEM AND POWER SUPPLY

(71) Applicant: Xiamen Ampack Technology Limited, Xiamen (CN)

(72) Inventors: Yong CHEN, Xiamen (CN); Kailin GUO, Xiamen (CN)

(73) Assignee: Xiamen Ampack Technology Limited, Xiamen (CN)

(21) Appl. No.: 19/437,729

(22) Filed: Dec. 31, 2025

(30) Foreign Application Priority Data
Dec. 31, 2024 (JP) 202411997450.2

(51) Int. Cl. H02M 3/00; H02J 7/00; H02J 7/90; H02M 1/00

(52) U.S. Cl. CPC H02M 3/01; H02J 7/855; H02J 7/933; H02M 1/0054; H02M 1/007; H02M 3/003

(57) ABSTRACT

A power conversion system, including: a first terminal and a second terminal of a first resonant converter on a first side are electrically connected to a first terminal and a second terminal of a battery pack respectively, and a first terminal of the first resonant converter on a second side is electrically connected to a DC bus at a first node; a second resonant converter, where a first terminal and a second terminal of the second resonant converter on a first side are electrically connected to the first terminal and the second terminal of the battery pack respectively, and a second terminal of the second resonant converter on a second side is electrically connected to the bus at a second node. A second terminal of the first resonant converter, and a first terminal of the second resonant converter, and the DC bus are electrically connected to a third node.

### CROSS REFERENCE TO RELATED APPLICATION

This application claims priority from Chinese Patent Application No. 202411997450.2, filed on Dec. 31, 2024, the content of which is incorporated herein by reference in its entirety.

### TECHNICAL FIELD

This application relates to the technical field of power electronics, and in particular, to a power conversion system and a power supply.

### BACKGROUND

In three-level circuit designs currently available for a power conversion system (PCS), it is generally necessary to maintain a neutral-point potential balance between a positive DC bus and a negative DC bus. The neutral-point potential balance is crucial for circuit performance and reliability. A neutral-point potential imbalance may increase the harmonic distortion rate of output voltage and current, thereby affecting electrical energy quality.

In a conventional scheme, an independent neutral-point balancing circuit is typically added between the positive bus and the negative bus. The neutral-point balancing circuit is typically formed of one inductor and two switching transistors, and implements a neutral-point balance by controlling the on state and off state of the two switching transistors. However, although the neutral-point serves to balance the neutral-point potential in various circuit designs, the circuit increases the algorithm workload in software, thereby resulting in losses in overall system operation.

### SUMMARY

A first aspect of this application provides a power conversion system. The power conversion system includes: a first resonant converter, where a first terminal of the first resonant converter on a first side is configured to be electrically connected to a first terminal of a battery pack, a second terminal of the first resonant converter on the first side is configured to be electrically connected to a second terminal of the battery pack, and a first terminal of the first resonant converter on a second side is electrically connected to a DC bus at a first node; a second resonant converter, where a first terminal of the second resonant converter on a first side is configured to be electrically connected to the first terminal of the battery pack, a second terminal of the second resonant converter on the first side is configured to be electrically connected to the second terminal of the battery pack, and a second terminal of the second resonant converter on a second side is electrically connected to the DC bus at a second node. A second terminal of the first resonant converter on a second side, a first terminal of the second resonant converter on a second side, and the DC bus are electrically connected to a third node. The first resonant converter and the second resonant converter are configured to balance a first voltage difference and a second voltage difference. It is defined that the first voltage difference U₁ is a voltage difference between the first node and the third node, and that the second voltage difference U₂ is a voltage difference between the third node and the second node.

In one or more embodiments of this application, the power conversion system further includes: a controller, configured to adjust a power of the first resonant converter and/or a power of the second resonant converter based on a difference between the first voltage difference and the second voltage difference, so as to adjust a voltage of the third node.

In the above technical solution, no neutral-point balancing circuit is required. The controller controls the switching frequency of a switching transistor in the first resonant converter and/or the second resonant converter, thereby regulating the power distribution and voltage output of the two resonant converters to maintain a potential balance of the third node between the positive DC bus and the negative DC bus, and consequently ensuring stable operation and superior performance of the power conversion system.

In one or more embodiments of this application, the power conversion system further includes: a first capacitor and a second capacitor disposed on the DC bus. The first capacitor is electrically connected between the first node and the third node. The second capacitor is electrically connected between the third node and the second node. The first voltage difference is a voltage difference across the first capacitor. The second voltage difference is a voltage difference across the second capacitor.

The first capacitor and the second capacitor are disposed between the positive DC bus and the negative DC bus, and the first capacitor and the second capacitor can play a role in maintaining the DC bus voltage stability, filtering out ripples, and providing instantaneous energy.

In one or more embodiments of this application, a capacitance difference between the first capacitor and the second capacitor is less than or equal to a first threshold.

By properly selecting and configuring the capacitance values of the first capacitor and the second capacitor, this application can improve the performance and reliability of a power electronics system, and also maintain a neutral-point potential balance between the positive DC bus and the negative DC bus.

In one or more embodiments of this application, the controller is configured to: increase a charging power of a target resonant converter corresponding to a first target voltage difference in response to a condition that the battery pack enters or stays in a charging state and a condition that the difference between the first voltage difference and the second voltage difference falls outside a first voltage range. The first target voltage difference is the greater one of the first voltage difference or the second voltage difference. The first resonant converter corresponds to the first voltage difference. The second resonant converter corresponds to the second voltage difference.

Considering an appropriate charging power required by the battery pack itself, when the difference between the first voltage difference and the second voltage difference falls outside the first voltage range, by preferentially adjusting the resonant converter corresponding to the larger voltage difference, this application ensures a sufficient charging power required by the battery itself, and implements fast charging of the battery pack.

In one or more embodiments of this application, the controller is configured to: decrease a charging power of a target resonant converter corresponding to a second target voltage difference in response to a condition that the battery pack enters or stays in a charging state and a condition that the difference between the first voltage difference and the second voltage difference falls outside a first voltage range. The second target voltage difference is the lesser of the first voltage difference or the second voltage difference. The first resonant converter corresponds to the first voltage difference. The second resonant converter corresponds to the second voltage difference.

If the difference between the first voltage difference and the second voltage difference falls outside the first voltage range, and the first voltage difference is greater than the second voltage difference, then the controller increases an equivalent resistance of the second resonant converter by decreasing the power of the second resonant converter. In this way, the equivalent resistance between the third node and the second node is increased, which increases the voltage division ratio across the DC bus. In this way, the second voltage difference is increased, and the difference between the first voltage difference and the second voltage difference is decreased, thereby balancing the neutral-point potential between the positive DC bus and the negative DC bus. Conversely, if the difference between the first voltage difference and the second voltage difference falls outside the first voltage range, and the first voltage difference is less than the second voltage difference, then the controller balances the potential of the third node by decreasing the power of the first resonant converter, the details of which are omitted here.

In one or more embodiments of this application, the controller is configured to: increase a charging power of the first resonant converter and/or decrease a charging power of the second resonant converter in response to a condition that the battery pack enters or stays in a charging state and a condition that the first voltage difference exceeds a withstand voltage of the first capacitor; and/or, the controller is further configured to decrease a charging power of the first resonant converter and/or increase a charging power of the second resonant converter in response to a condition that the battery pack enters or stays in a charging state and a condition that the second voltage difference exceeds a withstand voltage of the second capacitor.

If the first voltage difference exceeds the withstand voltage of the first capacitor, the controller increases the charging power of the first resonant converter and/or decreases the charging power of the second resonant converter. This is equivalent to reducing the equivalent resistance of the first resonant converter between the first node and the third node, and/or increasing the equivalent resistance of the second resonant converter between the third node and the second node. The first voltage difference between the first node and the third node is reduced to a value lower than the withstand voltage of the first capacitor due to the reduction of the voltage division ratio determined by the equivalent resistances, and the second voltage difference is also increased accordingly, thereby implementing overvoltage protection for the first capacitor. The overvoltage protection for the second capacitor is similar, the details of which are omitted here.

In one or more embodiments of this application, the power conversion system further includes: a two-phase AC-DC converter. A first terminal of the two-phase AC-DC converter on a first side is electrically connected to the first node. A second terminal of the two-phase AC-DC converter on the first side is electrically connected to the second node. A first live terminal and a neutral terminal of the two-phase AC-DC converter on a second side are configured to be electrically connected to a first load. A second live terminal and the neutral terminal of the two-phase AC-DC converter on the second side are configured to be electrically connected to a second load. The neutral terminal is electrically connected to the third node. The first live terminal and the second live terminal of the two-phase AC-DC converter on the second side are further configured to be electrically connected to an AC power supply. The controller is configured to: control, in response to a condition that the battery pack enters or stays in a charging state, the two-phase AC-DC converter to operate in a rectification mode; and control, in response to a condition that the battery pack enters or stays in a discharging state, the two-phase AC-DC converter to operate in an inversion mode.

When the battery pack enters or stays in a charging state, the controller controls the two-phase AC-DC converter to operate in a rectification mode. The two-phase AC-DC converter converts the AC voltage of the AC power supply into a DC voltage across the DC bus to charge the battery pack and store energy. When the battery pack enters or stays in a discharging state, the controller controls the two-phase AC-DC converter to operate in an inversion mode. The two-phase AC-DC converter converts the DC voltage across the DC bus into split-phase AC voltages on the first live terminal and the second live terminal to power the first load and the second load respectively.

In one or more embodiments of this application, the controller is configured to: adjust the power of the first resonant converter and/or a discharging power of the second resonant converter in response to a condition that the battery pack enters or stays in a discharging state and a condition that the difference between the first voltage difference and the second voltage difference falls outside a second voltage range, so as to adjust the voltage of the third node.

The controller controls the switching frequency of the switching transistor in the first resonant converter and/or the second resonant converter to regulate the power of the first resonant converter and/or the discharging power of the second resonant converter, so as to achieve a neutral-point potential balance during discharge of the battery pack, and in turn, ensure stable operation and superior performance of the entire power conversion system.

In one or more embodiments of this application, the controller is configured to: increase a discharging power of a target resonant converter corresponding to a third target voltage difference in response to a condition that the battery pack enters or stays in a discharging state and a condition that the difference between the first voltage difference and the second voltage difference falls outside the second voltage range. The third target voltage difference is the lesser of the first voltage difference or the second voltage difference. The first resonant converter corresponds to the first voltage difference. The second resonant converter corresponds to the second voltage difference.

When the battery pack enters or stays in a discharging state, if the difference between the first voltage difference and the second voltage difference falls outside the second voltage range, and the first voltage difference is less than the second voltage difference, then the first capacitor consumes a relatively large amount of electrical energy and the second capacitor consumes a relatively small amount of electrical energy. The controller increases the discharging power of the first resonant converter to compensate for the electrical energy consumed by the first capacitor, thereby producing an effect of increasing the first voltage difference. This reduces the difference between the first voltage difference and the second voltage difference, and restores the neutral-point potential to balance between the positive DC bus and the negative DC bus.

In one or more embodiments of this application, the controller is configured to: decrease a discharging power of a target resonant converter corresponding to a fourth target voltage difference in response to a condition that the battery pack enters or stays in a discharging state and a condition that the difference between the first voltage difference and a second voltage difference falls outside the second voltage range. The fourth target voltage difference is the greater one of the first voltage difference or the second voltage difference. The first resonant converter corresponds to the first voltage difference, and the second resonant converter corresponds to the second voltage difference.

In one or more embodiments of this application, the controller is configured to: decrease a discharging power of the first resonant converter in response to a condition that the battery pack enters or stays in a discharging state and a condition that a difference between the first voltage difference and a target voltage value is greater than a first voltage threshold; or, increase a discharging power of the first resonant converter in response to a condition that the battery pack enters or stays in a discharging state and a condition that a difference between the first voltage difference and a target voltage value is less than a second voltage threshold. The target voltage value U_{target} and the third voltage difference U₃ satisfy: |U_{target}−½×U₃|≤a third voltage threshold, and the third voltage difference U₃ is a voltage difference expected to be stabilized between the first node and the second node during discharge of the battery pack.

In this way, by adjusting the first resonant converter alone, the controller causes the first voltage difference to be close to or equal to the target voltage value U_{target}. In this way, the total DC voltage across the DC bus is kept stable and the neutral-point potential balance of the third node is ensured.

In one or more embodiments of this application, the controller is configured to: decrease a discharging power of the second resonant converter in response to a condition that the battery pack enters or stays in a discharging state and a condition that a difference between the second voltage difference and a target voltage value is greater than a fourth voltage threshold; or, increase a discharging power of the second resonant converter in response to a condition that the battery pack enters or stays in a discharging state and a condition that a difference between the second voltage difference and a target voltage value is less than a fifth voltage threshold. The target voltage value U_{target} and the third voltage difference U₃ satisfy: |U_{target}−½×U₃|≤a sixth voltage threshold. The third voltage difference U₃ is a voltage difference expected to be stabilized between the first node and the second node during discharge of the battery pack.

In this way, by adjusting the second resonant converter alone, the controller causes the second voltage difference to be close to or equal to the target voltage value U_{target}. In this way, the total DC voltage across the DC bus is kept stable and the neutral-point potential balance of the third node is ensured.

In one or more embodiments of this application, both a rated output power of the first resonant converter and a rated output power of the second resonant converter are less than a second threshold. The second threshold falls within [3 KW, 6 KW].

In a practical process of integrated fabrication of a circuit board of the power conversion system, because the rated output powers of both the first resonant converter and the second resonant converter are relatively small and close to each other, the dimensions of the first resonant converter and the second resonant converter can be close to each other and relatively small, thereby ensuring tidiness and smoothness during the integrated fabrication of the PCS circuit board. Furthermore, the cost of two low-power resonant converters is usually lower than the cost of one single high-power resonant converter. Therefore, the above design further reduces the manufacturing cost, and achieves dual benefits in terms of tidiness and cost-effectiveness.

In one or more embodiments of this application, the first resonant converter is a bidirectional DC-DC resonant converter, and the second resonant converter is a bidirectional DC-DC resonant converter.

In response to the battery pack entering or staying in a charging state, the controller adjusts the first resonant converter and the second resonant converter to step down the DC voltage across the DC bus, so that the voltage is converted for charging the battery pack. In response to the battery pack entering or staying in a discharging state, the controller adjusts the first resonant converter and the second resonant converter to step up the DC voltage of the battery pack, so that the voltage is converted for being output to the DC bus.

According to a second aspect, this application provides a power supply. The power supply includes the power conversion system according to any one of the embodiments in the first aspect. The battery pack is electrically connected to the power conversion system.

In one or more embodiments of this application, the battery pack includes a connector. The connector includes a first terminal and a second terminal. The first resonant converter is electrically connected to the first terminal and the second terminal separately. The second resonant converter is electrically connected to the first terminal and the second terminal separately. It is defined that the first terminal is a positive output terminal of the battery pack, and that the second terminal is a negative output terminal of the battery pack.

Compared to the prior art, in the power conversion system and the power supply provided in some embodiments of this application, the conventional single-channel high-power resonant converter is cleverly split into the first resonant converter and the second resonant converter. The first side of the first resonant converter and the first side of the second resonant converter are connected in parallel and are connected to the battery pack separately. The second side of the first resonant converter and the second side of the second resonant converter are connected in series and disposed on the DC bus. The first resonant converter and the second resonant converter replace the conventional high-power single-channel resonant converter to meet the voltage conversion requirements. In addition, the two resonant converters can dynamically balance the first voltage difference and the second voltage difference, serving a function of maintaining the neutral-point balance between the positive DC bus and the negative DC bus, thereby cancelling the separately designed neutral-point balancing circuit in the conventional technology. In this way, the neutral-point balancing circuit in the conventional technology is eliminated, thereby reducing the complexity of the circuit, reducing the workload of software algorithm of the power conversion system, reducing the overall system operation loss, and also bringing benefits in both efficiency and cost.

### BRIEF DESCRIPTION OF DRAWINGS

To describe the technical solutions of some embodiments of this application more clearly, the following outlines the drawings to be used in some embodiments of this application. The drawings outlined below are merely a part of embodiments of this application.

FIG. 1 is a schematic structural diagram of a power conversion system according to an embodiment of this application;

FIG. 2 is a schematic structural diagram of a neutral-point balancing circuit according to an embodiment of this application;

FIG. 3 is a schematic structural diagram of a power conversion system according to another embodiment of this application;

FIG. 4 is a schematic structural diagram of a power conversion system according to still another embodiment of this application;

FIG. 5 is a schematic structural diagram of a power conversion system according to still another embodiment of this application;

FIG. 6 is a schematic diagram of phases of a split-phase AC voltage according to an embodiment of this application;

FIG. 7 is a schematic structural diagram of a power conversion system according to still another embodiment of this application;

FIG. 8 is a schematic structural diagram of a power supply according to an embodiment of this application; and

FIG. 9 is a schematic structural diagram of a power supply according to another embodiment of this application.

### LIST OF REFERENCE SIGNS

10. first resonant converter; 20. second resonant converter; c1. first capacitor; c2. second capacitor; BUS. DC bus; BUS+. positive DC bus; BUS−. negative DC bus; N1. first node; N2. second node; N3. third node; U₁. first voltage difference; U₂. second voltage difference; 30. controller; 40. two-phase AC-DC converter; L1. first live terminal; L2. second live terminal; N. neutral terminal; load1. first load; load2. second load; K. protection switch; C3. voltage-stabilizing capacitor; 100. power conversion system; 200. battery pack; 50. connector; P+/P−. first terminal/second terminal of battery pack; 1000. power supply.

The drawings are not necessarily drawn to scale.

### DETAILED DESCRIPTION

To make the objectives, technical solutions, and advantages of some embodiments of this application clearer, the following gives a clear and detailed description of the technical solutions in some embodiments of this application with reference to the drawings in some embodiments of this application. Apparently, the described embodiments are merely a part of but not all of the embodiments of this application.

As used herein, the term “and/or” indicates merely a relation between related items, and represents three possible relationships. For example, “A and/or B” may represent the following three circumstances: A alone, both A and B, and B alone. In addition, the character “/” herein generally indicates an “or” relationship between the item preceding the character and the item following the character.

In the description hereof, a “connection” may be a direct connection, or may be an indirect connection implemented through an intermediary, or may be internal communication between two components. A person of ordinary skill in the art is able to understand the specific meanings of the terms in this application according to specific situations.

In an embodiment of this application, a first node, a second node, and a third node are defined merely for ease of describing the circuit structure. The first node, the second node, and the third node are not actual circuit units.

Some embodiments of this application provide a power conversion system and a power conversion system control method. The specific implementation of some embodiments of this application is described in further detail below with reference to drawings.

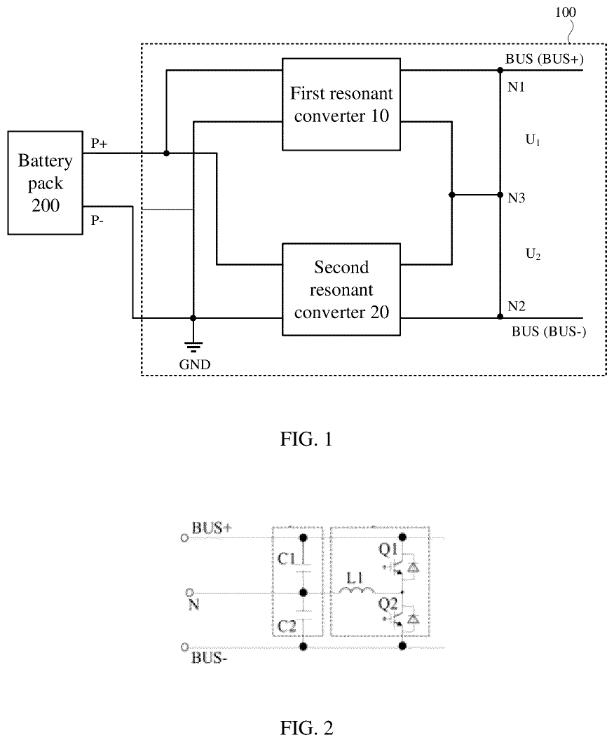

FIG. 1 is a schematic structural diagram of a power conversion system according to an embodiment of this application. The power conversion system in this application such as a split-phase power conversion system is configured to process single-phase AC voltage (for example, in a 120 V/240 V split-phase system) and convert the AC voltage into a DC voltage or convert DC voltage into a split-phase AC voltage (with a 180° phase difference). The power conversion system provided in this application is widely applicable the fields such as energy storage systems, renewable energy systems, and electric vehicle charging piles. For example, an energy storage system includes a portable power supply.

As shown in FIG. 1, a power conversion system 100 provided in an embodiment of this application includes a first resonant converter 10 and a second resonant converter 20.

A first terminal of the first resonant converter 10 on a first side is configured to be electrically connected to a first terminal P+ of a battery pack 200. A second terminal of the first resonant converter 10 on the first side is configured to be electrically connected to a second terminal P− of the battery pack 200. A first terminal of the first resonant converter 10 on a second side is electrically connected to a DC bus at a first node N1.

A first terminal of the second resonant converter 20 on a first side is configured to be electrically connected to the first terminal P+ of the battery pack 200. A second terminal of the second resonant converter 20 on the first side is configured to be electrically connected to the second terminal P− of the battery pack 200. A second terminal of the second resonant converter 20 on a second side is electrically connected to the DC bus BUS at a second node N2.

A second terminal of the first resonant converter 10 on a second side, a first terminal of the second resonant converter 20 on a second side, and the DC bus BUS are electrically connected to a third node N3.

The first resonant converter 10 and the second resonant converter 20 are configured to balance a first voltage difference U₁ and a second voltage difference U₂.

It is defined that the first voltage difference U₁ is a voltage difference between the first node N1 and the third node N3, and that the second voltage difference U₂ is a voltage difference between the third node N3 and the second node N2.

The battery pack 200 operates in two states: a charging state, and a discharging state. When entering or staying in a charging state, the battery pack 200 receives a DC voltage to undergo charging and energy storage. When entering or staying in a discharging state, the battery pack 200 outputs a DC voltage to power a load.

In some instances, the second terminal P− of the battery pack 200 is also electrically connected to the reference ground GND to provide a stable reference potential for the circuit, reduce external interference, ensure normal operation of the circuit, and improve circuit safety.

In some embodiments of this application, the DC bus BUS includes a high-voltage DC bus and a low-voltage DC bus. The low-voltage DC bus is a DC bus through which the first side of the first resonant converter 10 and the first side of the second resonant converter 20 are connected to the first terminal P+ and the second terminal P− of the battery pack 200. In a practical product, the low-voltage DC bus corresponds to a power harness that connects the battery pack 200 and the power conversion system 100. Generally, the power conversion system 100 is connected to the first terminal P+ of the battery pack 200 by a red power harness, and the power conversion system 100 is connected to the second terminal P− of the battery pack 200 by a black power harness.

The high-voltage DC bus is a DC bus connected to the second side of the first resonant converter 10 and the second side of the second resonant converter 20. In practical products, the high-voltage DC bus is understood to be a conductive copper wire printed on a circuit board corresponding to the power conversion system 100.

Understandably, the high voltage and low voltage referred to herein are relative. Simply put, the first side of the first resonant converter 10 is a low voltage side, and the second side of the first resonant converter 10 is a high voltage side.

Understandably, the DC bus BUS referred to in this application and the accompanying drawings primarily represents the high-voltage DC bus. The DC bus BUS in this application is an intermediate link that connects the battery pack 200 and the load, and is used for energy storage, voltage conversion, or power transmission. Using an example in which the first terminal P+ of the battery pack 200 outputs a positive voltage, and the second terminal P− of the battery pack outputs a negative voltage or zero voltage, the DC bus BUS specifically includes a positive DC bus BUS+ and a negative DC bus BUS−, as shown in FIG. 1.

The first node N1 is an intersection of the positive DC bus BUS+ and the first terminal of the first resonant converter 10 on the second side, the second node N2 is an intersection of the negative DC bus BUS− and the second terminal of the second resonant converter 20 on the second side, and the third node N3 is a neutral point between the positive DC bus BUS+ and the negative DC bus BUS−.

A resonant converter is a highly efficient, high-power-density power electronics converter widely used in power conversion systems 100. The resonant converter can be used to implement conversion between different voltage levels in a DC system. During operation, the resonant converter may implement a soft switching technology through a resonant circuit, thereby improving efficiency, reducing switching losses, and reducing electromagnetic interference.

In a power conversion system in the related art, to meet the DC voltage level conversion requirements during charging and discharging of a battery pack, a single-channel resonant converter with a relatively high rated output power usually needs to be employed to implement direct current to direct current (DC-DC) conversion. Furthermore, to maintain a neutral-point potential balance of the DC bus, a neutral-point balancing circuit formed of one inductor L1 and two switching transistors Q1 and Q2 is also required, as shown in FIG. 2.

In this application, the conventional single-channel high-power resonant converter is cleverly split into the first resonant converter 10 and the second resonant converter 20. The first side of the first resonant converter 10 and the first side of the second resonant converter 20 are connected in parallel and are electrically connected to the two terminals of the battery pack 200 respectively. The second side of the first resonant converter 10 and the second side of the second resonant converter 20 are connected in series and disposed between the positive DC bus BUS+ and the negative DC bus BUS−.

The first resonant converter 10 and the second resonant converter 20 are used to replace the conventional high-power single-channel resonant converter to meet the voltage conversion requirements. Furthermore, the two resonant converters dynamically balance the first voltage difference U₁ and the second voltage difference U₂, and serves the function of maintaining a neutral point (that is, third node N3) balance between the positive DC bus and the negative DC bus. In this way, the neutral-point balancing circuit designed separately in the related art is eliminated, thereby reducing the complexity of the circuit, reducing the workload of software algorithm of the power conversion system 100, reducing the overall system operation loss, and also bringing benefits in both efficiency and cost.

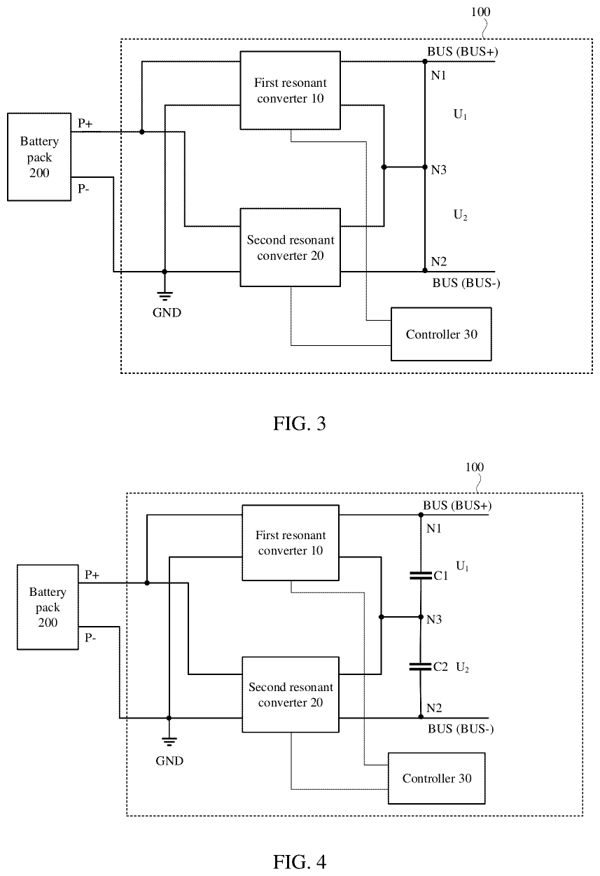

Referring to FIG. 3, according to some embodiments of this application, the power conversion system 100 further includes: a controller 30, configured to adjust a power of the first resonant converter 10 and/or a power of the second resonant converter 20 based on a difference between the first voltage difference U₁ and the second voltage difference U₂, so as to adjust the voltage of the third node N3.

In an example of this application, the controller 30 is a microcontroller unit (MCU), a digital signal processor (DSP), or the like. The controller 30 is responsible for receiving an external signal and performing corresponding control based on a program.

The controller 30 samples the first voltage difference U₁ and the second voltage difference U₂ through a sensor, a voltage divider circuit, or the like. A fluctuation detected in the first voltage difference U₁ and the second voltage difference U₂ indicates a fluctuation in the potential of the third node N3. If the difference between the first voltage difference U₁ and the second voltage difference U₂ is relatively large, that is, if the potential fluctuation of the third node N3 is significant, then the potential of the third node N3 needs to be adjusted to balance the first voltage difference U₁ and the second voltage difference U₂.

In this case, the controller 30 controls the switching frequency of a switching transistor in the first resonant converter 10 and/or the second resonant converter 20 to regulate the power distribution and voltage output of the two resonant converters. This maintains a potential balance of the third node N3 between the positive DC bus BUS+ and the negative DC bus BUS−, thereby ensuring stable operation and superior performance of the power conversion system 100.

In this embodiment, by regulating the voltage output and power distribution of the two resonant converters, the voltage distribution on the DC buses is dynamically adjusted and balanced, and the voltage difference between the first voltage difference U₁ and the second voltage difference U₂ is reduced. In this way, when the battery pack 200 discharges electricity to an external load, the DC component of the AC current is reduced, the reactive power loss of the electrical device is reduced, and the stability and operating efficiency of the power conversion system 100 are improved.

Referring to FIG. 4, according to some embodiments of this application, the power conversion system 100 further includes: a first capacitor C1 and a second capacitor C2 disposed on the DC bus BUS.

The first capacitor C1 is electrically connected between the first node N1 and the third node N3, and the second capacitor C2 is electrically connected between the third node N3 and the second node N2,

The first voltage difference U₁ is a voltage difference across the first capacitor C₁, and the second voltage difference U₂ is a voltage difference across the second capacitor C2.

In this embodiment, the first capacitor C1 and the second capacitor C2 are disposed between the positive DC bus BUS+ and the negative DC bus BUS−, and the first capacitor C1 and the second capacitor C2 play a role in maintaining the DC bus voltage stability, filtering out ripples, and providing instantaneous energy.

Understandably, in a specific process of selecting the first capacitor C1 and the second capacitor C2, appropriate capacitance values are selected based on the power requirement and ripple requirement of the power conversion system 100, so as to improve system reliability.

In this embodiment, the capacitor is in the form of a single capacitor. In other embodiments, the capacitor is integrated by connecting capacitors in series, parallel, or series-and-parallel pattern, which is not limited herein.

In some embodiments of this application, a capacitance difference between the first capacitor C1 and the second capacitor C2 is less than or equal to a first threshold.

In a specific process of selecting appropriate models of the capacitors, the capacitance values of the first capacitor C1 and the second capacitor C2 need to be approximate. This improves the system stability and the filtering effect. As an example, a first capacitor C1 and a second capacitor C2 of the same model are selected so that the capacitance values of the first capacitor C1 and the second capacitor C2 are approximate. For example, the difference in capacitance between the first capacitor C1 and the second capacitor C2 does not exceed ±15%.

For the voltage fluctuations on the DC bus BUS, the task of smoothing the voltage fluctuations is typically undertaken by both the first capacitor C1 and the second capacitor C2. The two capacitors with approximate capacitance values can more evenly share the voltage fluctuations, prevent one capacitor from being subjected to excessive voltage or current stress, and avoid jitters of the neutral-point potential between the positive DC bus and the negative DC bus.

When supplying energy to a load, the capacitance values of the first capacitor C1 and the second capacitor C2 are approximate, so that the two capacitors share the energy demand more evenly, thereby avoiding an abrupt voltage drop or overcharge that affects the neutral-point balance between the positive DC bus and the negative DC bus. If the capacitance difference between the first capacitor C1 and the second capacitor C2 is significant, the energy distribution may be uneven, thereby affecting the dynamic performance of the power conversion system 100.

In this embodiment, by properly selecting and configuring the capacitance values of the first capacitor C1 and the second capacitor C2, this application improves the performance and reliability of the power electronics system, and maintains a neutral-point potential balance between the positive DC bus and the negative DC bus.

According to some embodiments of this application, the controller 30 is configured to: increase a charging power of a target resonant converter corresponding to a first target voltage difference in response to a condition that the battery pack 200 enters or stays in a charging state and a condition that the difference between the first voltage difference U₁ and the second voltage difference U₂ falls outside a first voltage range.

The first target voltage difference is the greater one of the first voltage difference U the second voltage difference U₂, the first resonant converter 10 corresponds to the first voltage difference U₁, and the second resonant converter 20 corresponds to the second voltage difference U₂.

The first voltage range is, for example, [−20 V, 20 V]. The first voltage range specifically depends on the performance requirements of the power conversion system 100, and is not limited herein.

In this embodiment, if the battery pack 200 enters or stays in a charging state, and the difference between the first voltage difference U₁ and the second voltage difference U₂ falls outside the first voltage range, then it indicates that the first voltage difference U₁ is significantly different from the second voltage difference U₂, and the potential balance of the third node N3 is affected.

As an example, if the difference between the first voltage difference U₁ and the second voltage difference U₂ exceeds 20 V, that is, the first voltage difference U₁ is greater than the second voltage difference U₂, then the controller 30 increases the charging power of the first resonant converter 10 to reduce the first voltage difference U₁ . In this way, the difference between the first voltage difference U₁ and the second voltage difference U₂ is reduced, thereby achieving the purpose of balancing the potential of the third node N3.

If the difference between the first voltage difference U₁ and the second voltage difference U₂ is less than −20 V, that is, the first voltage difference U₁ is less than the second voltage difference U₂, then the controller 30 increases the charging power of the second resonant converter 20 to reduce the second voltage difference U₂. In this way, the difference between the first voltage difference U₁ and the second voltage difference U₂ is reduced, thereby achieving the purpose of balancing the potential of the third node N3.

When the battery pack 200 enters or stays in a charging state, the principles of the power regulation are as follows:

When the first voltage difference U₁ needs to be reduced, the controller increases the charging power of the first resonant converter 10, which is equivalent to reducing the equivalent resistance of the first resonant converter 10 between the first node N1 and the third node N3.

In the case that the battery pack 200 is being charged, the total DC voltage provided between the positive DC bus BUS+ and the negative DC bus BUS−remains substantially stable, for example, stabilized at approximately 500 V. The equivalent resistance between the first node N1 and the third node N3 is decreased, thereby reducing the voltage division ratio for 500 V between the first node N1 and the third node N3, and consequently reducing the first voltage difference U₁. In a reverse circumstance, the principles also apply, and are not repeated here.

In this embodiment, considering an appropriate charging power required by the battery pack 200 itself, when the difference between the first voltage difference U₁ and the second voltage difference U₂ falls outside the first voltage range, by adjusting the resonant converter corresponding to the larger voltage difference, this application ensures a sufficient charging power required by the battery itself, and implements fast charging of the battery pack 200.

According to some embodiments of this application, the controller 30 is configured to: decrease a charging power of a target resonant converter corresponding to a second target voltage difference in response to a condition that the battery pack 200 enters or stays in a charging state and a condition that the difference between the first voltage difference U₁ and the second voltage difference U₂ falls outside a first voltage range.

The second target voltage difference is the lesser of the first voltage difference U₁ or the second voltage difference U₂, the first resonant converter corresponds to the first voltage difference U₁, and the second resonant converter corresponds to the second voltage difference U₂.

In this embodiment, if the difference between the first voltage difference U₁ and the second voltage difference U₂ falls outside the first voltage range, and the first voltage difference U₁ is greater than the second voltage difference U₂, then the controller increases an equivalent resistance of the second resonant converter 20 by decreasing the power of the second resonant converter 20.

In this way, the equivalent resistance between the third node N3 and the second node N2 is increased, which increases the voltage division ratio across the DC bus BUS. In this way, the second voltage difference U₂ is increased, and the difference between the first voltage difference U₁ and the second voltage difference U₂ is decreased, thereby balancing the N3 neutral-point potential between the positive DC bus and the negative DC bus.

Conversely, if the difference between the first voltage difference U₁ and the second voltage difference U₂ falls outside the first voltage range, and the first voltage difference U₁ is less than the second voltage difference U₂, then the controller 30 balances the potential of the third node N3 by decreasing the power of the first resonant converter 10, the details of which are omitted here.

In some instances, the battery pack 200 enters or stays in a charging state, and the total DC voltage across the DC bus BUS is stabilized, for example, at 500 V. The difference between the first voltage difference U₁ and the second voltage difference U₂ indicates the extent to which the voltage at the third node N3 deviates from half of the total DC voltage (for example, 250 V). The difference between the first voltage difference U₁ and the second voltage difference U₂ falling outside the first voltage range indicates that the voltage of the third node N3 deviates significantly from half of the total DC voltage. In this case, the voltage of the third node N3 needs to be regulated to a value close to or approximately equal to half of the total DC voltage to achieve a balance.

As an example, when the battery pack 200 enters or stays in a charging state, the first voltage range is [−20 V, 20 V]. For example, if the first voltage difference U₁ is 255 V and the second voltage difference U₂ is 245 V, that is, the difference between the first voltage difference U₁ and the second voltage difference U₂ does not exceed [−20 V, 20 V], then the first resonant converter 10 and the second resonant converter 20 do not need to be controlled. However, if the first voltage difference U₁ is 270 V and the second voltage difference U₂ is 230 V, that is, the difference between the first voltage difference U₁ and the second voltage difference U₂ exceeds [−20 V, 20 V],

In this case, the controller 30 only increases the charging power of the first resonant converter 10 to reduce the equivalent resistance between the first node N1 and the third node N3. This reduces the voltage division ratio across the DC bus BUS, and reduces the first voltage difference U₁ to approximately 250 V. As a result of the change in the voltage division ratio across the 500 V DC bus, the second voltage difference U₂ increases to approximately 250 V accordingly, thereby reducing the difference between the first voltage difference U₁ and the second voltage difference U₂, and keeping a balance of the N3 neutral-point potential between the positive DC bus and the negative DC bus.

Alternatively, the controller 30 only decreases the charging power of the second resonant converter 20 to increase the equivalent resistance between the third node N3 and the second node N2, thereby increasing the voltage division ratio across the DC bus BUS. In this way, the second voltage difference U₂ is increased to approximately 250 V. As a result of the change in the voltage division ratio across the 500 V DC bus, the first voltage difference U₁ decreases to approximately 250 V accordingly, thereby reducing the difference between the first voltage difference U₁ and the second voltage difference U₂, and keeping a balance of the N3 neutral-point potential between the positive DC bus and the negative DC bus.

Alternatively, the controller 30 both increases the charging power of the first resonant converter 10 and decreases the charging power of the second resonant converter 20, thereby reducing the equivalent resistance between the first node N1 and the third node N3 and increasing the equivalent resistance between the third node N3 and the second node N2. Due to the voltage division effect of the equivalent resistance, the first voltage difference U₁ decreases to approximately 250 V, and the second voltage difference U₂ increases to approximately 250 V, thereby keeping a balance of the N3 neutral-point potential between the positive DC bus and the negative DC bus.

According to some embodiments of this application, the controller 30 is configured to:
increase a charging power of the first resonant converter 10 and/or decrease a charging power of the second resonant converter 20 in response to a condition that the battery pack 200 enters or stays in a charging state and a condition that the first voltage difference U₁ exceeds a withstand voltage of the first capacitor C1;
and/or,
decrease a charging power of the first resonant converter 10 and/or increase a charging power of the second resonant converter 20 in response to a condition that the battery pack 200 enters or stays in a charging state and a condition that the second voltage difference U₂ exceeds a withstand voltage of the second capacitor C2.

When the power conversion system is operating, the voltages across the first capacitor C1 and the second capacitor C2 are generally not allowed to exceed a withstand voltage thereof. The withstand voltage is a maximum voltage that the capacitors can safely withstand. If the voltage across a capacitor exceeds the withstand voltage thereof, the voltage may damage the capacitor and lead to loss of the energy storage capacity of the capacitor, and in severe cases, may cause a circuit fault.

Therefore, in this embodiment, when the battery pack 200 enters or stays in a charging state, the controller 30 detects whether the first voltage difference U₁ exceeds the withstand voltage of the first capacitor C1 and whether the second voltage difference U₂ exceeds the withstand voltage of the second capacitor C2.

If the first voltage difference U₁ exceeds the withstand voltage of the first capacitor C1, for example, if the first voltage difference U₁ is 350 V and the withstand voltage of the first capacitor C1 is 330 V, then the controller 30 increases the charging power of the first resonant converter 10 and/or decreases the charging power of the second resonant converter 20. This is equivalent to reducing the equivalent resistance of the first resonant converter 10 between the first node N1 and the third node N3 and increasing the equivalent resistance of the second resonant converter 20 between the third node N3 and the second node N2. For the first voltage difference U₁ between the first node N1 and the third node N3, the first voltage difference U₁ is reduced to a value lower than the withstand voltage of the first capacitor C1 due to the reduction of the voltage division ratio determined by the equivalent resistances, and the second voltage difference U₂ is also increased accordingly, thereby implementing overvoltage protection for the device of the first capacitor C1.

If the second voltage difference U₂ exceeds the withstand voltage of the second capacitor C2, the controller 30 increases the charging power of the second resonant converter 20 and/or decreases the charging power of the first resonant converter 10. This is equivalent to reducing the equivalent resistance of the second resonant converter 20 between the third node N3 and the second node N2 and increasing the equivalent resistance of the first resonant converter 10 between the first node N1 and the third node N3. For the second voltage difference U₂ between the third node N3 and the second node N2, the second voltage difference U₂ is reduced to a value lower than the withstand voltage of the second capacitor C2 due to the reduction of the voltage division ratio determined by the equivalent resistances, and the first voltage difference U₁ is also increased accordingly, thereby implementing overvoltage protection for the device of the second capacitor C2.

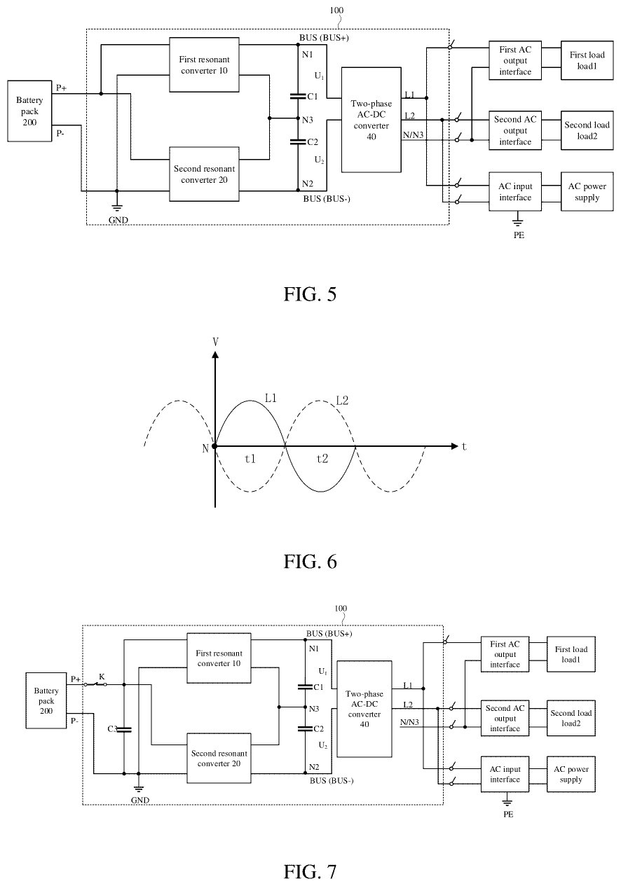

Referring to FIG. 5 (without showing the controller 30), according to some embodiments of this application, the power conversion system 100 further includes: a two-phase AC-DC converter 40.

A first terminal of the two-phase AC-DC converter 40 on the first side is electrically connected to a first node N1. A second terminal of the two-phase AC-DC converter 40 on the first side is electrically connected to a second node N2.

A first live terminal L1 and a neutral terminal N of the two-phase AC-DC converter 40 on a second side are configured to be electrically connected to a first load load1. A second live terminal L2 and the neutral terminal N of the two-phase AC-DC converter 40 on the second side are configured to be electrically connected to a second load load2. The neutral terminal N is electrically connected to the third node N3.

The first live terminal L1 and the second live terminal L2 of the two-phase AC-DC converter 40 on the second side are further configured to be electrically connected to an AC power supply.

The controller 30 is configured to: control, in response to the battery pack 200 entering or staying in a charging state, the two-phase AC-DC converter 40 to operate in a rectification mode; and control, in response to the battery pack 200 entering or staying in a discharging state, the two-phase AC-DC converter 40 to operate in an inversion mode.

In this embodiment, the two-phase AC-DC converter 40 is formed of two independent single-phase AC-DC converters, each handling one of the two phases of the AC power supply. The two-phase AC-DC converter 40 is configured to convert an AC voltage into a DC voltage, or convert a DC voltage into an AC voltage.

The AC power supply is configured to provide an AC voltage. In this embodiment, the AC power supply is a mains power grid or another power supply capable of outputting an AC voltage, such as a generator, which is not limited herein.

In some embodiments of this application, the battery pack 200 is disposed in a portable power supply. The portable power supply supplies power to a first load load1 and a second load load2. For example, the first load and the second load include: electrical tools, laptop computers, hair dryers, induction cookers, rice cookers, vehicle refrigerators, microwave ovens, and the like, which are not particularly limited herein.

Specifically, during operation, when the battery pack 200 enters or stays in a charging state, the controller 30 controls the two-phase AC-DC converter 40 to operate in a rectification mode. The two-phase AC-DC converter 40 converts the AC voltage of the AC power supply into a DC voltage across the DC bus BUS to charge the battery pack 200 and store energy. When the battery pack 200 enters or stays in a discharging state, the controller 30 controls the two-phase AC-DC converter 40 to operate in an inversion mode. The two-phase AC-DC converter 40 converts the DC voltage across the DC bus BUS into a split-phase AC voltage (with a 180° phase difference) on the first live terminal L1 and the second live terminal L2 to power the first load load1 and the second load load2 respectively.

Still referring to FIG. 5, in this embodiment, the power conversion system 100 is further configured to be electrically connected to a first AC output interface, a second AC output interface, and an AC input interface. For example, the power conversion system 100 is electrically connected to the first AC output interface, the second AC output interface, and the AC input interface by power harnesses separately. The first AC output interface, the second AC output interface, and the AC input interface are disposed on a portable power supply. The portable power supply includes the power conversion system 100. The first AC output interface, the second AC output interface, and the AC input interface are electrically connected to the power conversion system 100 separately by wires led out of the power conversion system 100.

The first AC output interface is configured to be connected to the first load load1. A live terminal of the first AC output interface is electrically connected to a first live terminal L1 of the two-phase AC-DC converter 40 on the second side. A neutral terminal of the first AC output interface is electrically connected to a neutral terminal N of the two-phase AC-DC converter 40 on the second side.

The second AC output interface is configured to be connected to the second load load2. A live terminal of the second AC output interface is electrically connected to a second live terminal L2 of the two-phase AC-DC converter 40 on the second side. A neutral terminal of the second AC output interface is electrically connected to a neutral terminal N of the two-phase AC-DC converter 40 on the second side.

The AC input interface is configured to be connected to an AC power supply. A first terminal of the AC input interface is electrically connected to the first live terminal L1 of the two-phase AC-DC converter 40 on the second side. A second terminal of the AC input interface is electrically connected to the second live terminal L2 of the two-phase AC-DC converter 40 on the second side.

The AC input interface further includes a ground terminal PE. In this way, when an AC power supply is provided to the second side of the two-phase AC-DC converter 40 through the AC input interface, the ground terminal PE is grounded to protect the AC input interface.

To ensure flexible switching between a load connected-and-powered state and an AC input-for-charging state of the two-phase AC-DC converter 40, in some embodiments of this application, corresponding control switches are provided on connection paths that connect the first AC output interface, the second AC output interface, and the AC input interface to the two-phase AC-DC converter 40 separately, as shown in FIG. 5, so that the corresponding circuits can be flexibly connected or disconnected as needed.

According to some embodiments of this application, the controller 30 is configured to: adjust the power of the first resonant converter 10 and/or a discharging power of the second resonant converter 20 in response to a condition that the battery pack 200 enters or stays in a discharging state and a condition that the difference between the first voltage difference U₁ and the second voltage difference U₂ falls outside a second voltage range, so as to adjust the voltage of the third node N3.

The second voltage range is, for example, [−20 V, 20 V] or [−25 V, 25 V]. The second voltage range specifically depends on the performance requirements of the power conversion system 100, and is not limited herein.

In this embodiment, when the battery pack 200 enters or stays in a discharging mode, the potential of the third node N3 is prone to oscillation and fluctuation in some scenarios such as a scenario in which the power is uneven between the two loads connected to the second side of the two-phase AC-DC converter 40, or a scenario in which the first load load1 or the second load load2 is switched from a fully loaded state to an unloaded state. In such scenarios, the controller 30 keeps a voltage balance of the third node N3 by adjusting the power of the first resonant converter 10 and/or the discharging power of the second resonant converter 20.

As an example, when the load powers are uneven between the first load load1 and the second load load2, for example, when the rated power of the first load load1 is 800 W and the rated power of the second load load2 is 200 W, the first capacitor C1 and the second capacitor C2 are prone to uneven voltages, thereby causing the potential of the third node N3 to oscillate and fluctuate, affecting the quality of the AC voltage output by the two-phase AC-DC converter 40, and tending to cause distortion of the output voltage.

In this example, the controller 30 controls the switching frequency of the switching transistor in the first resonant converter 10 and/or the second resonant converter 20 to adjust the power of the first resonant converter 10 and/or the discharging power of the second resonant converter 20, so as to rectify a neutral-point potential imbalance caused by a load imbalance during discharge of the battery pack 200, and in turn, ensure stable operation and superior performance of the entire power conversion system 100.

According to some embodiments of this application, the controller 30 is configured to: increase a discharging power of a target resonant converter corresponding to a third target voltage difference in response to a condition that the battery pack 200 enters or stays in a discharging state and a condition that the difference between the first voltage difference U₁ and the second voltage difference U₂ falls outside a second voltage range. The third target voltage difference is the lesser of the first voltage difference U₁ or the second voltage difference U₂, the first resonant converter 10 corresponds to the first voltage difference U₁, and the second resonant converter 20 corresponds to the second voltage difference U₂.

Specifically, when the battery pack 200 enters or stays in a discharging state, if the difference between the first voltage difference U₁ and the second voltage difference U₂ falls outside the second voltage range, and the first voltage difference U₁ is less than the second voltage difference U₂, then the first capacitor C1 consumes a relatively large amount of electrical energy and the second capacitor C2 consumes a relatively small amount of electrical energy.

In this case, the controller 30 increases the discharging power of the first resonant converter 10 to compensate for the electrical energy consumed by the first capacitor C1, thereby producing an effect of increasing the first voltage difference U₁. This reduces the difference between the first voltage difference U₁ and the second voltage difference U₂, and restores the N3 neutral-point potential to balance between the positive DC bus and the negative DC bus.

If the difference between the first voltage difference U₁ and the second voltage difference U₂ falls outside the second voltage range, and the first voltage difference U₁ is greater than the second voltage difference U₂, then the first capacitor C1 consumes a relatively small amount of electrical energy and the second capacitor C2 consumes a relatively large amount of electrical energy.

In this case, the controller 30 increases the discharging power of the second resonant converter 20 to compensate for the electrical energy consumed by the second capacitor C2, thereby producing an effect of increasing the second voltage difference U₂. This reduces the difference between the first voltage difference U₁ and the second voltage difference U₂, and restores the N3 neutral-point potential to balance between the positive DC bus and the negative DC bus.

According to some embodiments of this application, the controller 30 is configured to: decrease a discharging power of a target resonant converter corresponding to a fourth target voltage difference in response to a condition that the battery pack 200 enters or stays in a discharging state and a condition that the difference between the first voltage difference U₁ and the second voltage difference U₂ falls outside a second voltage range. The fourth target voltage difference is the greater one of the first voltage difference U₁ or the second voltage difference U₂, the first resonant converter 10 corresponds to the first voltage difference U₁, and the second resonant converter 20 corresponds to the second voltage difference U₂.

Specifically, when the battery pack 200 enters or stays in a discharging state, if the difference between the first voltage difference U₁ and the second voltage difference U₂ falls outside the second voltage range, and the first voltage difference U₁ is less than the second voltage difference U₂, then the first capacitor C1 consumes a relatively large amount of electrical energy and the second capacitor C2 consumes a relatively small amount of electrical energy.

In this case, the controller 30 decreases the discharging power of the second resonant converter 20, thereby producing an effect of decreasing the second voltage difference U₂. This reduces the difference between the first voltage difference U₁ and the second voltage difference U₂, and restores the N3 neutral-point potential to balance between the positive DC bus and the negative DC bus.

If the difference between the first voltage difference U₁ and the second voltage difference U₂ falls outside the second voltage range, and the first voltage difference U₁ is greater than the second voltage difference U₂, then the first capacitor C1 consumes a relatively small amount of electrical energy and the second capacitor C2 consumes a relatively large amount of electrical energy.

In this case, the controller 30 decreases the discharging power of the first resonant converter 10, thereby producing an effect of decreasing the first voltage difference U₁. This reduces the difference between the first voltage difference U₁ and the second voltage difference U₂, and restores the N3 neutral-point potential to balance between the positive DC bus and the negative DC bus.

The principles of neutral-point balancing in a discharge state are described in detail below.

As an example, a first load load1 is connected between the first live terminal L1 and the neutral terminal N of the two-phase AC-DC converter 40 on the second side. The rated power of the first load load1 is 800 W. A second load load2 is connected between the second live terminal L2 and the neutral terminal N of the two-phase AC-DC converter 40 on the second side. The rated power of the second load load2 is 200 W.

The single-phase AC voltage output from the first live terminal L1 and the single-phase AC voltage output from the second live terminal L2 of the two-phase AC-DC converter 40 on the second side are 180° out of phase with each other. If the frequency of the AC voltages output from the first live terminal L1 and the second live terminal L2 is 50 Hz, then one AC cycle is 0.02 second. In this example, the second voltage range is [−20 V, 20 V].

Referring to FIG. 6, when the battery pack 200 enters or stays in a discharging state, within 0.01 second of the first half cycle (for example, t1), the first live terminal L1 draws power from the first capacitor C1 to power the first load load1, and the second live terminal L2 draws power from the second capacitor C2 to power the second load load2. Because the rated power of the first load load1 is greater than the rated power of the second load load2, this may cause the neutral terminal N, that is, the third node N3, to shift in potential toward the phase with a heavier load, resulting in a change (step-up) in the N3 neutral-point voltage between the positive DC bus and the negative DC bus. Consequently, the difference between the first voltage difference U₁ and the second voltage difference U₂ is less than −20 V, thereby affecting the quality of the power supply for the loads.

In this case, because the electrical energy Q of the first capacitor C1 is Q=C×U₁, the electrical energy supplied to the first capacitor C1 by the first resonant converter 10 during discharge of the battery pack 200 is: W=P(LLC1)×t. The controller 30 increases the discharging power of the first resonant converter 10 to compensate for the electrical energy of the first capacitor C1, thereby producing an effect of increasing the first voltage difference U₁.

Similarly, the controller 30 decreases the discharging power of the second resonant converter 20, thereby producing an effect of reducing the second voltage difference U₂. In this way, the difference between the first voltage difference U₁ and the second voltage difference U₂ is reduced to a value within [−20 V, 20 V], and the N3 neutral-point potential between the positive DC bus and the negative DC bus is restored to balance.

Within 0.01 second of the last half cycle (for example, t2), the first live terminal L1 draws power from the second capacitor C2 to power the first load load1, and the second live terminal L2 draws power from the first capacitor C1 to power the second load load2. Because the rated power of the first load load1 is greater than the rated power of the second load load2, this may cause the neutral terminal N, that is, the third node N3, to shift in potential toward the phase with a heavier load, resulting in a change (step-down) in the neutral-point voltage between the positive DC bus BUS+ and the negative DC bus BUS−. Consequently, the difference between the first voltage difference U₁ and the second voltage difference U₂ is greater than 20 V, thereby affecting the quality of the power supply for the loads.

In this case, because the electrical energy Q of the first capacitor C1 is Q=C×U₁, the electrical energy supplied to the first capacitor C1 by the first resonant converter 10 during discharge of the battery pack 200 is: W=P(LLC1)×t. The controller 30 decreases the discharging power of the first resonant converter 10 to reduce the electrical energy supplied to the first capacitor C1, thereby producing an effect of decreasing the first voltage difference U₁.

Similarly, the controller 30 increases the discharging power of the second resonant converter 20, thereby producing an effect of increasing the second voltage difference U₂. In this way, the difference between the first voltage difference U₁ and the second voltage difference U₂ is reduced, and the neutral-point potential between the positive DC bus and the negative DC bus is restored to balance.

As another example, a first load load1 is connected between the first live terminal L1 and the neutral terminal N of the two-phase AC-DC converter 40 on the second side. The rated power of the first load load1 is 500 W. A second load load2 is connected between the second live terminal L2 and the neutral terminal N of the two-phase AC-DC converter 40 on the second side. The rated power of the second load load2 is 500 W.

Within 0.01 second of the first half cycle (for example, t1), if the first load load1 between the first live terminal L1 and the neutral terminal N of the two-phase AC-DC converter 40 on the second side is switched from a full-load state to a no-load state (no load connected), the first voltage difference U₁ may be caused to increase.

In this case, the controller 30 decreases the discharging power of the first resonant converter 10 to reduce the charging energy for the first capacitor C1, thereby reducing the first voltage difference U₁, and/or, the controller 30 increases the discharging power of the second resonant converter 20 to increase the charging energy for the second capacitor C2, thereby increasing the second voltage difference U₂, and ultimately achieving a potential balance of the third node N3. The specific implementation principles may be learned with reference to the preceding example and are not repeated here.

According to some embodiments of this application, the controller 30 is configured to:
decrease a discharging power of the first resonant converter 10 in response to a condition that the battery pack 200 enters or stays in a discharging state and a condition that a difference between the first voltage difference U₁ and a target voltage value is greater than a first voltage threshold;
or,
increase a discharging power of the first resonant converter 10 in response to a condition that the battery pack 200 enters or stays in a discharging state and a condition that a difference between the first voltage difference U₁ and a target voltage value is less than a second voltage threshold.

The target voltage value U_{target} and the third voltage difference U₃ satisfy: |U_{target}−½×U₃|≤a third voltage threshold, and the third voltage difference U₃ is a voltage difference expected to be stabilized between the first node N1 and the second node N2 during discharge of the battery pack 200.

In practical applications, when the battery pack 200 enters or stays in a discharging mode, it is necessary to maintain a stable total DC voltage across the DC bus BUS to ensure normal operation of the load and smooth operation of the system. Therefore, if the battery pack 200 enters or stays in a discharging mode, in addition to performing the balance between the first voltage difference U₁ and the second voltage difference U₂ as described above, a target voltage value U_{target} is further set. Benchmarked against the target voltage value, the first voltage difference U₁ is adjusted to be close to or equal to the target voltage value, and the second voltage difference U₂ is adjusted to be close to or equal to the target voltage value U_{target}, thereby further maintaining stability of the voltage across the DC bus BUS.

In some embodiments, an absolute value of a difference between the target voltage value and a half of the total DC voltage expected to be stabilized on the DC bus BUS is less than or equal to a third voltage threshold. The third voltage threshold is determined depending on the performance requirements of the power conversion system 100 and is not limited herein. For example, if the voltage across the DC bus BUS is expected to be stabilized at 500 V and the third voltage threshold is set to 5 V, then the range of the target voltage value is [245 V, 255 V]. Understandably, when the battery pack 200 enters or stays in a discharging state, the third voltage difference U₃ is a voltage expected to be stabilized on the DC bus BUS, that is, a voltage difference expected to be stabilized between the first node N1 and the second node N2. In some embodiments of this application, when the second node N2 is at zero potential, an absolute value of a difference between the target voltage value and the voltage of the third node N3 is less than or equal to the third voltage threshold.

In some embodiments, the controller 30 monitors the first voltage difference U₁, calculates a difference between U₁ and U_{target}, and decreases the discharging power of the first resonant converter 10 in response to the difference between U₁ and U_{target} being greater than a first voltage threshold. Alternatively, the controller 30 increases the discharging power of the first resonant converter 10 in response to the difference between U₁ and U_{target} being less than a second voltage threshold.

For example, the battery pack 200 enters or stays in a discharging state, and the voltage on the DC bus BUS is expected to be stabilized at 500 V, that is, the third voltage difference U₃ is 500 V. The U_{target} is set to half of the third voltage difference U₃, that is, 250 V. The first voltage threshold is 20 V. The second voltage threshold is −20 V. This application includes the following embodiments:
1) U₁=265 V, the difference between U₁ and U_{target} does not exceed the first voltage threshold 20 V, the difference (15 V) between U₁ and U_{target} does not exceed the first voltage threshold 20 V, and the difference (15 V) between U₁ and U_{target} is not less than the second voltage threshold −20 V. The controller 30 maintains the current control of the first resonant converter 10.
2) U₁=280 V, and the difference (30V) between U₁ and U_{target} exceeds the first voltage threshold 20 V. The controller 30 decreases the discharging power of the first resonant converter 10, so as to reduce U₁ to a value close to or equal to 250 V.
3) U₁=220 V, and the difference (−30 V) between U₁ and U_{target} is less than the second voltage threshold −20 V. The controller 30 increases the discharging power of the first resonant converter 10, so as to increase U₁ to a value close to or equal to 250 V.

In this way, by adjusting the first resonant converter 10 alone, the controller 30 causes the first voltage difference U₁ to be close to or equal to the target voltage value U_{target}. In this way, the total DC voltage across the DC bus BUS is kept stable and the neutral-point potential balance of the third node N3 is ensured.

According to some embodiments of this application, the controller 30 is configured to:
decrease a discharging power of the second resonant converter 20 in response to a condition that the battery pack 200 enters or stays in a discharging state and a condition that a difference between the second voltage difference U₂ and a target voltage value is greater than a fourth voltage threshold;
or,
increase a discharging power of the second resonant converter 20 in response to a condition that the battery pack 200 enters or stays in a discharging state and a condition that a difference between the second voltage difference U₂ and a target voltage value is less than a fifth voltage threshold.

The target voltage value U_{target} and the third voltage difference U₃ satisfy: |U_{target}−½×U₃|≤a sixth voltage threshold, and the third voltage difference U₃ is a voltage difference expected to be stabilized between the first node N1 and the second node N2 during discharge of the battery pack 200.

In some embodiments, an absolute value of a difference between the target voltage value and a half of the total DC voltage expected to be stabilized on the DC bus BUS is less than or equal to a sixth voltage threshold. The sixth voltage threshold is determined depending on the performance requirements of the power conversion system 100 and is not limited herein. For example, if the voltage across the DC bus BUS is expected to be stabilized at 500 V and the sixth voltage threshold is set to 5 V, then the range of the target voltage value is [245 V, 255 V]. Understandably, when the battery pack 200 enters or stays in a discharging state, the third voltage difference U₃ is a voltage expected to be stabilized on the DC bus BUS, that is, a voltage difference expected to be stabilized between the first node N1 and the second node N2.

In some embodiments, the controller 30 monitors the second voltage difference U₂, calculates a difference between U₂ and U_{target}, and decreases the discharging power of the second resonant converter 20 in response to the difference between U₂ and U_{target} being greater than a fourth voltage threshold. Alternatively, the controller 30 increases the discharging power of the second resonant converter 20 in response to the difference between U₂ and U_{target} being less than a fifth voltage threshold.

For example, the battery pack 200 enters or stays in a discharging state, and the voltage on the DC bus BUS is expected to be stabilized at 500 V, that is, the third voltage difference U₃ is 500 V. The U_{target} is set to half of the third voltage difference U₃, that is, 250 V. The fourth voltage threshold is 20 V. The fifth voltage threshold is −20 V. This application includes the following embodiments:
1) U₂=265 V, the difference (15 V) between U₂ and U_{target} does not exceed the fourth voltage threshold 20 V, and the difference (15 V) between U₂ and U_{target} is not less than the fifth voltage threshold −20 V. The controller 30 maintains the current control of the second resonant converter 20.
2) U₂=280 V, and the difference (30V) between U₂ and U_{target} exceeds the fourth voltage threshold 20 V. The controller 30 decreases the discharging power of the second resonant converter 20, so as to reduce U₂ to a value close to or equal to 250 V.
3) U₂=220 V, and the difference (−30 V) between U₂ and U_{target} is less than the fifth voltage threshold −20 V. The controller 30 increases the discharging power of the second resonant converter 20, so as to increase U₂ to a value close to or equal to 250 V.

In this way, by adjusting the second resonant converter 20 alone, the controller 30 causes the second voltage difference U₂ to be close to or equal to the target voltage value U_{target}. In this way, the total DC voltage across the DC bus BUS is kept stable and the neutral-point potential balance of the third node N3 is ensured.

According to some embodiments of this application, both a rated output power of the first resonant converter 10 and a rated output power of the second resonant converter 20 are less than a second threshold. In some embodiments of this application, the second threshold falls within [3 KW, 6 KW].

In a power conversion system in the related art, a single-channel resonant converter with a relatively high rated output power is employed to meet the DC voltage level conversion requirements during charging and discharging of a battery pack 200, and the rated output power is, for example, 7.2 KW. However, in practical applications, the dimensions of a resonant converter are usually correlated to the rated output power of the resonant converter. A higher rated output power corresponds to larger dimensions and a higher price.

In this embodiment, after the conventional single-channel high-power resonant converter is cleverly split into two smaller-power resonant converters, the rated output powers of the first resonant converter 10 and the second resonant converter 20 are further limited to [3 KW, 6 KW].

In this way, in a practical process of integrated fabrication of a circuit board of the power conversion system 100, because the rated output powers of both the first resonant converter 10 and the second resonant converter 20 are relatively small and close to each other, the dimensions of the first resonant converter 10 and the second resonant converter 20 can be close to each other and relatively small, thereby ensuring tidiness and smoothness during the integrated fabrication of the PCS circuit board. Furthermore, the cost of two low-power resonant converters is usually lower than the cost of one single high-power resonant converter. Therefore, the above design further reduces the manufacturing cost, and achieves dual benefits in terms of tidiness and cost-effectiveness.

According to some embodiments of this application, the first resonant converter 10 is a bidirectional DC-DC resonant converter, and the second resonant converter 20 is a bidirectional DC-DC resonant converter.

In response to the battery pack 200 entering or staying in a charging state, the controller 30 adjusts the first resonant converter 10 and the second resonant converter 20 to step down the DC voltage across the DC bus BUS, so that the voltage is converted for charging the battery pack 200.

More specifically, as regulated by the controller 30, the first resonant converter 10 steps down the DC voltage between the first node N1 and the third node N3 and uses the voltage to charge the battery pack 200, and the second resonant converter 20 steps down the DC voltage between the third node N3 and the second node N2 and uses the voltage to charge the battery pack 200.

In response to the battery pack 200 entering or staying in a discharging state, the controller 30 adjusts the first resonant converter 10 and the second resonant converter 20 to step up the DC voltage of the battery pack 200, so that the voltage is converted for being output to the DC bus BUS.

More specifically, as regulated by the controller 30, the first resonant converter 10 steps up the DC voltage across the battery pack 200 and then outputs the voltage to the first node N1 and the second node N2. The second resonant converter 20 steps up the DC voltage across the battery pack 200 and then outputs the voltage to the third node N3 and the second node N2.

As shown in FIG. 7 (the controller 30 is not shown), in some examples, the power conversion system 100 further includes a protection switch K.

A first terminal of the protection switch K is configured to be electrically connected to a first terminal P+ of the battery pack 200, and a second terminal of the protection switch K is configured to be electrically connected to a first terminal of the first resonant converter 10 on the first side and a first terminal of the second resonant converter 20 on the first side.

In some instances, the protection switch K includes a fuse or a Metal-Oxide-Semiconductor Field-Effect Transistor (MOSFET). Definitely, in other instances, the switch may be another type of switch, which is not limited herein.

In this embodiment, the protection switch K is a fuse, for example. With the fuse disposed, when a fault such as overcurrent or a short circuit occurs in the circuit, the fuse quickly blows out to cut off the power supply and protect the circuit from damage caused by the overcurrent or short circuit. During normal operation, the fuse remains closed, ensuring normal energy storage and inversion operations.

Furthermore, in some embodiments, still referring to FIG. 7, the power conversion system 100 further includes a voltage-stabilizing capacitor C3.

A first electrode of the voltage-stabilizing capacitor C3 is configured to be electrically connected to the first terminal P+ of the battery pack 200, and a second electrode of the voltage-stabilizing capacitor C3 is configured to be electrically connected to the second terminal P−of the battery pack 200.

In this embodiment, a voltage-stabilizing capacitor C3 is disposed between the first terminal P+ and the second terminal P− of the battery pack 200. This allows the capacitor C3 to absorb any voltage fluctuations (such as instantaneous voltage spikes or fluctuations) during the charging and discharging of the battery pack 200, thereby making the voltage smoother and more stable, and also ensuring a neutral-point potential balance between the positive DC bus and the negative DC bus.

In addition, high-frequency noise may be generated during the charging and discharging of the battery pack 200. The voltage-stabilizing capacitor C3 can effectively filter out the high-frequency noise, thereby improving the overall electromagnetic compatibility (EMC) and stability of the system.

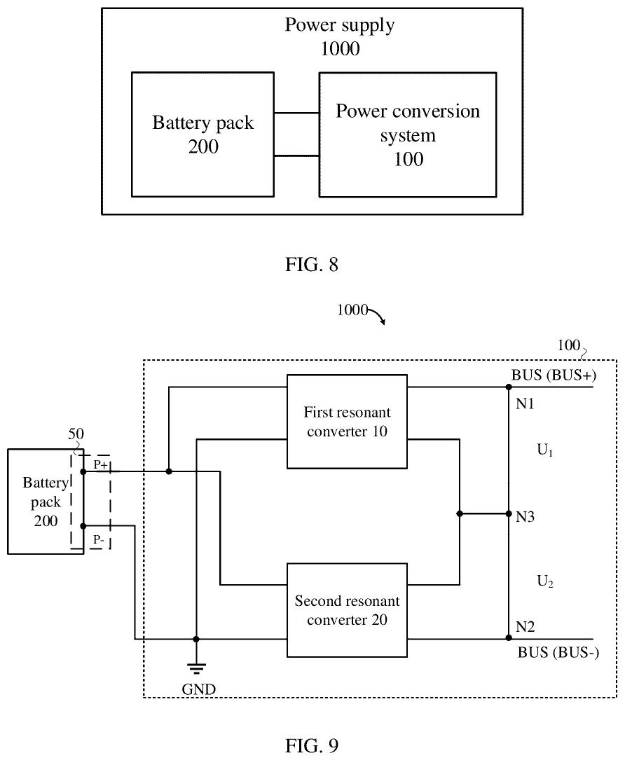

Based on the same inventive concept, as shown in FIG. 8, this application further provides a power supply 1000. The power supply 1000 includes a battery pack 200 and the power conversion system 100 disclosed in any one of the above embodiments of this application. The battery pack 200 is electrically connected to the power conversion system 100.

As an example, the power supply is a portable power supply, such as a small DC power bank, or a medium-sized AC-DC power bank. The portable power supply comes in many types, and different types of portable power supplies usually provide different functions and powers, depending on the application scenarios and needs.

According to some embodiments of this application, as shown in FIG. 9, the battery pack 200 provided in an embodiment of this application includes a connector 50.

The connector 50 includes a first terminal P+ and a second terminal P−. The first resonant converter 10 is electrically connected to the first terminal P+ and the second terminal P− separately, and the second resonant converter 20 is electrically connected to the first terminal P+ and the second terminal P− separately. It is defined that the first terminal P+ is a positive output terminal of the battery pack 200, and that the second terminal P− is a negative output terminal of the battery pack 200.

In some instances, the first resonant converter 10 is electrically connected to the first terminal P+ and the second terminal P− in the connector 50 separately by using a power harness, and the second resonant converter 20 is electrically connected to the first terminal P+ and the second terminal P− in the connector 50 separately by using a power harness.

More specifically, the first terminal of the first resonant converter 10 on the first side is electrically connected to the first terminal P+ in the connector 50 by using a power harness, and the second terminal of the first resonant converter 10 on the first side is electrically connected to the second terminal P− in the connector 50 by using a power harness. The first terminal of the second resonant converter 20 on the first side is electrically connected to the first terminal P+ in the connector 50 by using a power harness, and the second terminal of the second resonant converter 20 on the first side is electrically connected to the second terminal P− in the connector 50 by using a power harness.

Understandably, the power supply 1000 provided herein includes the power conversion system disclosed above, and therefore, achieves the beneficial effects of the power conversion system 100 provided herein. For details of the beneficial effects, reference may be made to the specific description of the power conversion system 100 in the above embodiments, the details are not repeated here.

In some embodiments, the battery pack 200 further includes a battery management system (BMS) and a battery module. The battery management system is electrically connected to the battery module by a power harness and a communication harness. During charging and discharging of the battery module, the current flows through the power harness, and the battery management system acquires, through a signal harness, information on the battery module such as the voltage and temperature of the battery module, and the voltage of each cell in the battery module.

The battery module includes a plurality of battery cells connected in series, parallel, or series-and-parallel pattern, and is configured to store and provide electrical energy. The battery management system is configured to manage and control the charging and discharging processes of the cell module to improve the utilization efficiency of the cell module, reduce faults, and the like. The series-and-parallel connection of battery cells means that the connections between the battery cells include both series connection and parallel connection. Although this application has been described with reference to exemplary embodiments, various improvements may be made to the embodiments without departing from the scope of this application, and the components of this application may be replaced with equivalents. Particularly, to the extent that no structural conflict exists, various technical features mentioned in various embodiments may be combined in any manner. This application is not limited to the specific embodiments disclosed herein, but includes all technical solutions falling within the scope of the claims.

What is claimed is:

1. A power conversion system, wherein the power conversion system comprises:
a first resonant converter, wherein a first terminal of the first resonant converter on a first side is configured to be electrically connected to a first terminal of a battery pack, a second terminal of the first resonant converter on the first side is configured to be electrically connected to a second terminal of the battery pack, and a first terminal of the first resonant converter on a second side is electrically connected to a DC bus at a first node;
a second resonant converter, wherein a first terminal of the second resonant converter on a first side is configured to be electrically connected to the first terminal of the battery pack, a second terminal of the second resonant converter on the first side is configured to be electrically connected to the second terminal of the battery pack, and a second terminal of the second resonant converter on a second side is electrically connected to the DC bus at a second node;
a second terminal of the first resonant converter on a second side, a first terminal of the second resonant converter on a second side, and the DC bus are electrically connected to a third node; and
the first resonant converter and the second resonant converter are configured to balance a first voltage difference and a second voltage difference,
wherein, it is defined that the first voltage difference U₁ is a voltage difference between the first node and the third node, and that the second voltage difference U₂ is a voltage difference between the third node and the second node.

2. The power conversion system according to claim 1, wherein the power conversion system further comprises:
a controller, configured to adjust a power of the first resonant converter and/or a power of the second resonant converter based on a difference between the first voltage difference and the second voltage difference, so as to adjust a voltage of the third node.

3. The power conversion system according to claim 2, wherein the power conversion system further comprises: a first capacitor and a second capacitor disposed on the DC bus; and
the first capacitor is electrically connected between the first node and the third node, and the second capacitor is electrically connected between the third node and the second node,
wherein, the first voltage difference is a voltage difference across the first capacitor, and the second voltage difference is a voltage difference across the second capacitor.

4. The power conversion system according to claim 3, wherein
a capacitance difference between the first capacitor and the second capacitor is less than or equal to a first threshold.

5. The power conversion system according to claim 2, wherein the controller is configured to:
increase a charging power of a target resonant converter corresponding to a first target voltage difference in response to a condition that the battery pack enters or stays in a charging state and a condition that the difference between the first voltage difference and the second voltage difference falls outside a first voltage range,
wherein, the first target voltage difference is the greater one of the first voltage difference or the second voltage difference, the first resonant converter corresponds to the first voltage difference, and the second resonant converter corresponds to the second voltage difference.

6. The power conversion system according to claim 2, wherein the controller is configured to:
decrease a charging power of a target resonant converter corresponding to a second target voltage difference in response to a condition that the battery pack enters or stays in a charging state and a condition that the difference between the first voltage difference and the second voltage difference falls outside a first voltage range,
wherein, the second target voltage difference is the lesser of the first voltage difference or the second voltage difference, the first resonant converter corresponds to the first voltage difference, and the second resonant converter corresponds to the second voltage difference.

7. The power conversion system according to claim 2, wherein the controller is configured to:
increase a charging power of the first resonant converter and/or decrease a charging power of the second resonant converter in response to a condition that the battery pack enters or stays in a charging state and a condition that the first voltage difference exceeds a withstand voltage of the first capacitor;
and/or,
the controller is further configured to decrease a charging power of the first resonant converter and/or increase a charging power of the second resonant converter in response to a condition that the battery pack enters or stays in a charging state and a condition that the second voltage difference exceeds a withstand voltage of the second capacitor.

8. The power conversion system according to claim 2, wherein the power conversion system further comprises: a two-phase AC-DC converter;
a first terminal of the two-phase AC-DC converter on a first side is electrically connected to the first node, a second terminal of the two-phase AC-DC converter on the first side is electrically connected to the second node, a first live terminal and a neutral terminal of the two-phase AC-DC converter on a second side are configured to be electrically connected to a first load, a second live terminal and the neutral terminal of the two-phase AC-DC converter on the second side are configured to be electrically connected to a second load, and the neutral terminal is electrically connected to the third node;
the first live terminal and the second live terminal of the two-phase AC-DC converter on the second side are further configured to be electrically connected to an AC power supply;
the controller is configured to:
control, in response to a condition that the battery pack enters or stays in a charging state, the two-phase AC-DC converter to operate in a rectification mode; and
control, in response to a condition that the battery pack enters or stays in a discharging state, the two-phase AC-DC converter to operate in an inversion mode.

9. The power conversion system according to claim 8, wherein the controller is configured to:
adjust the power of the first resonant converter and/or a discharging power of the second resonant converter in response to a condition that the battery pack enters or stays in a discharging state and a condition that the difference between the first voltage difference and the second voltage difference falls outside a second voltage range, so as to adjust the voltage of the third node.

10. The power conversion system according to claim 9, wherein the controller is configured to:
increase a discharging power of a target resonant converter corresponding to a third target voltage difference in response to a condition that the battery pack enters or stays in a discharging state and a condition that the difference between the first voltage difference and the second voltage difference falls outside the second voltage range,
wherein, the third target voltage difference is the lesser of the first voltage difference or the second voltage difference, the first resonant converter corresponds to the first voltage difference, and the second resonant converter corresponds to the second voltage difference.

11. The power conversion system according to claim 9, wherein the controller is configured to:
decrease a discharging power of a target resonant converter corresponding to a fourth target voltage difference in response to a condition that the battery pack enters or stays in a discharging state and a condition that the difference between the first voltage difference and the second voltage difference falls outside the second voltage range,
the fourth target voltage difference is the greater one of the first voltage difference or the second voltage difference, the first resonant converter corresponds to the first voltage difference, and the second resonant converter corresponds to the second voltage difference.

12. The power conversion system according to claim 8, wherein the controller is configured to:
decrease a discharging power of the first resonant converter in response to a condition that the battery pack enters or stays in a discharging state and a condition that a difference between the first voltage difference and a target voltage value is greater than a first voltage threshold;
or,
increase a discharging power of the first resonant converter in response to a condition that the battery pack enters or stays in a discharging state and a condition that a difference between the first voltage difference and a target voltage value is less than a second voltage threshold; and
the target voltage value U_{target} and the third voltage difference U₃ satisfy: |U_{target}−½×U₃|≤a third voltage threshold, and the third voltage difference U₃ is a voltage difference expected to be stabilized between the first node and the second node during discharge of the battery pack.

13. The power conversion system according to claim 8, wherein the controller is configured to:
decrease a discharging power of the second resonant converter in response to a condition that the battery pack enters or stays in a discharging state and a condition that a difference between the second voltage difference and a target voltage value is greater than a fourth voltage threshold;
or,
increase a discharging power of the second resonant converter in response to a condition that the battery pack enters or stays in a discharging state and a condition that a difference between the second voltage difference and a target voltage value is less than a fifth voltage threshold; and
the target voltage value U_{target} and the third voltage difference U₃ satisfy: |U_{target}−½×U₃|≤a sixth voltage threshold, and the third voltage difference U₃ is a voltage difference expected to be stabilized between the first node and the second node during discharge of the battery pack.

14. The power conversion system according to claim 1, wherein
both a rated output power of the first resonant converter and a rated output power of the second resonant converter are less than a second threshold; and
the second threshold falls within [3 KW, 6 KW].

15. The power conversion system according to claim 1, wherein
the first resonant converter is a bidirectional DC-DC resonant converter;
the second resonant converter is a bidirectional DC-DC resonant converter.

16. A power supply, characterized in that the power supply comprises a battery pack and the power conversion system according to claim 1, and the battery pack is electrically connected to the power conversion system.

17. The power supply according to claim 16, wherein the battery pack comprises a connector;
the connector comprises a first terminal and a second terminal, the first resonant converter is electrically connected to the first terminal and the second terminal separately, and the second resonant converter is electrically connected to the first terminal and the second terminal separately; and
it is defined that the first terminal is a positive output terminal of the battery pack, and that the second terminal is a negative output terminal of the battery pack.
